(19) United States
(12) Patent Application Publication
(10) Pub. No.: US 2026/0276606 A1
(43) Pub. Date: Sep. 17, 2026

(54) LIQUID CHROMATOGRAPHY PISTON

(71) Applicant: CHANGZHOU RUIXI BIOTECHNOLOGY CO., LTD., Changzhou (CN)

(72) Inventors: Zhonghui LI, Changzhou (CN); Zhongwei LI, Changzhou (CN)

(21) Appl. No.: 19/672,811

(22) Filed: May 11, 2026

Related U.S. Application Data
(63) Continuation of application No. PCT/CN2024/144264, filed on Dec. 31, 2024.

(30) Foreign Application Priority Data
Dec. 5, 2024 (CN) 202411778820.3

(51) Int. Cl. G01N 30/60; B01D 15/14; B01D 15/18; G01N 30/02; G01N 30/38

(52) U.S. Cl. CPC G01N 30/6021; B01D 15/14; B01D 15/1885; G01N 30/38; G01N 2030/027

(57) ABSTRACT

A liquid chromatography piston includes a connecting plate, below which two chromatographic columns are fixed, two pistons respectively slidably disposed within the two chromatographic columns and located above the stationary phase packing, two nuts rotatably disposed on the connecting plate and respectively in threaded connection with the two threaded tubes, rotating each nut allows adjustment of a position of one piston within one chromatographic column, two connecting strips, and two liquid inlet tubes respectively slidably arranged within the two threaded tubes, upper ends of the two liquid inlet tubes respectively pass through the two connecting strips and are fixedly connected to one flow guide fixed above the connecting plate, a sample tube and a cleaning agent tube are provided above the flow guide, the sample tube is configured to introduce a mobile phase sample, and the cleaning agent tube is configured to introduce a cleaning agent.

### CROSS-REFERENCE TO RELATED APPLICATION

This application is a continuation of PCT application serial no. PCT/CN2024/144264, filed on Dec. 31, 2024, which claims the priority and benefit of Chinese patent application serial no. 202411778820.3, filed on Dec. 5, 2024. The entireties of the PCT application serial no. PCT/CN2024/144264 and the Chinese patent application serial no. 202411778820.3 are hereby incorporated by reference herein and made a part of this specification.

### TECHNICAL FIELD

The present application relates to the technical field of detection devices, and, in particular, to a liquid chromatography piston.

### DESCRIPTION OF RELATED ART

Liquid chromatography technology, as an efficient and sensitive separation and analysis method, plays a significant role in a wide range of fields including chemistry, biology, medicine, and environmental science. A liquid chromatography device includes a chromatographic column, a high-pressure pump, a sample injector, a detector, and a data processing system. The chromatographic column is a core component of the liquid chromatography device, and is internally filled with a stationary phase packing. A sample solution (i.e., a mobile phase) is driven through the chromatographic column under high pressure, where different components therein are separated due to their different partition coefficients between the stationary phase and the mobile phase. The high-pressure pump is configured to provide the high pressure required for the mobile phase to pass through the chromatographic column. The stability and flow precision of the high-pressure pump are crucial for the separation effect. The sample injector is configured to inject the sample into the mobile phase, allowing it to enter the chromatographic column for separation along with the mobile phase. The detector is configured to detect components flowing out from the chromatographic column, and convert them into electrical signals for recording and analysis. Common detectors include ultraviolet detectors, fluorescence detectors, mass spectrometry detectors, etc. The data processing system is configured to collect, process, and analyze signals output by the detector, obtain a chromatogram of the sample, and subsequently perform qualitative and quantitative analysis of the sample.

After each separation, a portion of the sample and the mobile phase may remain inside the chromatographic column. These residues may cause interference during the next separation, resulting in errors in the separation results. Therefore, the chromatographic column needs to be cleaned after each separation to remove the residues. However, the cleaning process is not only time-consuming and labor-intensive, but may also affect the service life and separation efficiency of the chromatographic column. Furthermore, incomplete cleaning may lead to contamination and clogging of the chromatographic column, further affecting the separation effect.

Most existing liquid chromatography devices operate in an intermittent manner, that is, only one sample can be separated at a time. After completing the separation of one sample, the device needs to be stopped for operations such as cleaning the chromatographic column and replacing the mobile phase before the next sample separation can begin. This operation manner not only decreases operation efficiency, but also increases operational complexity and cost. Furthermore, due to the uncertainty of the downtime, it may also affect the stability and repeatability of the separation results.

Therefore, it is necessary to provide a liquid chromatography piston to solve the problems described in the aforementioned background technology.

### SUMMARY

To achieve the above objectives, the present application provides a liquid chromatography piston, including:
a connecting plate, where two chromatographic columns are fixed below the connecting plate, each of the two chromatographic columns is internally filled with a stationary phase packing and is provided with a liquid outlet at a lower end of each of the two chromatographic columns, and the liquid outlet is connected to a continuous chromatograph,
two pistons, where the two pistons are respectively slidably disposed within the two chromatographic columns and located above the stationary phase packing, a threaded tube is fixed above each of the two pistons, an outer wall of the threaded tube is provided with threads, an upper end of the threaded tube passes through the connecting plate and extends upwards, and a lower end of the threaded tube passes through a respective one of the two pistons and is fixedly connected to a bottom of a respective one of the two pistons,
two nuts, where the two nuts are rotatably disposed on the connecting plate and respectively in threaded connection with the two threaded tubes, rotating each of the two nuts allows adjustment of a position of a respective one of the two pistons within a respective one of the two chromatographic columns, thereby changing a column length and a column pressure of a respective one of the two chromatographic columns,
two connecting strips, where the two connecting strips are respectively fixed to upper ends of the two threaded tubes, and
two liquid inlet tubes, where the two liquid inlet tubes are respectively slidably arranged within the two threaded tubes, upper ends of the two liquid inlet tubes respectively pass through the two connecting strips and are fixedly connected to a same one flow guide, the flow guide is fixed above the connecting plate, a sample tube and a cleaning agent tube are provided above the flow guide, the sample tube is configured to introduce a mobile phase sample, and the cleaning agent tube is configured to introduce a cleaning agent.

Furthermore, sieve plates are respectively disposed at lower ends of the two threaded tubes and at the liquid outlets.

Furthermore, two vertical guide rods are fixed above the connecting plate, and the two connecting strips are respectively slidably sleeved on the two guide rods.

Furthermore, a lifting gear is fixedly sleeved on an outer side of each of the two nuts, and the two lifting gears mesh with each other. A drive gear is rotatably disposed on the connecting plate, and the drive gear meshes with one of the two lifting gears. A gear drive motor configured to drive the two lifting gears to rotate is connected below the connecting plate.

Furthermore, a storage tank is fixedly connected behind each of the two chromatographic columns, the storage tank is filled with the stationary phase packing, and a lower portion of each of the two chromatographic columns communicates with the storage tank via a connecting tube.

Furthermore, a transport screw is rotatably provided within the connecting tube, the transport screw is fitted against an inner wall of the connecting tube, a first end of the transport screw extends into a respective one of the two chromatographic columns, and a second end of the transport screw rotatably passes through the storage tank and extends out of the storage tank. A screw drive motor configured to drive the transport screw to rotate is provided outside the storage tank.

Furthermore, the flow guide is a cylindrical cavity with side cavities respectively on two sides of the flow guide, and the two liquid inlet tubes respectively lead into the two side cavities. The sample tube and the cleaning agent tube respectively lead into the flow guide at a front side and a rear side of the flow guide.

Furthermore, a rotating shaft is rotatably connected to a center of the flow guide, two symmetrically arranged flow guide plates are respectively fixed on two sides of the rotating shaft, each of the two symmetrically arranged flow guide plates is sector-shaped and has an arc length greater than both an inner diameter of the sample tube and an inner diameter of the cleaning agent tube as well as a width of each of the side cavities, and ends of the two symmetrically arranged flow guide plate are respectively fitted against an inner wall of the flow guide.

Furthermore, a lower end of the rotating shaft passes through the flow guide and extends out from a lower side of the flow guide, a flow guide gear is fixed to the lower end of the rotating shaft, and the flow guide gear is rotatably erected above the connecting plate. A transmission ring gear is fixed to one of the two lifting gears, and the transmission ring gear meshes with the flow guide gear.

Furthermore, the one of the two lifting gears rotate to drive the rotating shaft to rotate, and when one of the two pistons in a first of the two chromatographic columns slides downward to compress the stationary phase packing, the sample tube communicates with a respective one of the two liquid inlet tubes corresponding to the first chromatographic column, and the cleaning agent tube communicates with a respective one of the two liquid inlet tubes corresponding to a second of the two chromatographic columns.

The beneficial effects of the present application compared with the existing technology are as follows:
In the present application, the position of the piston within the chromatographic column can be easily adjusted, thereby altering the column pressure and column length. This enables the device to adapt to samples of different structures and complexities, ensuring that each sample achieves optimal separation effect. For simple samples, a short column and lower column pressure is sufficient to meet the separation requirements, thereby shortening analytical time and improving analytical efficiency. For complex samples, a long column and higher column pressure is sufficient to provide better separation efficiency and resolution, ensuring that each component in the sample is effectively separated.
In the present application, the two positions can slide synchronously in opposite directions, allowing sample separation can be performed in one chromatographic column while the other chromatographic column is being cleaned. This ensures continuous separation and purification of samples, improving the efficiency of chromatography analysis. When the piston slides upward to decrease the column pressure, the cleaning agent can flow sufficiently through the stationary phase packing, carrying away residual samples, thereby enhancing cleaning efficiency.
In the present application, the flow guide plates within the flow guide allows sample and cleaning agent to flow to different chromatographic columns, and automatically selects which chromatographic column to deliver the sample or the cleaning agent to according to the current position of the piston, ensuring the continuity and efficiency of sample separation and cleaning.

### BRIEF DESCRIPTION OF THE DRAWINGS

FIG. 1 is a schematic view of an overall structure of a liquid chromatography piston;

FIG. 2 is a schematic view of the liquid chromatography piston after a chromatographic column is cut open;

FIG. 3 is a front sectional view of two chromatographic columns;

FIG. 4 is a side sectional view of one chromatographic column;

FIG. 5 is a schematic view of a flow guide.

### DESCRIPTION OF THE EMBODIMENTS

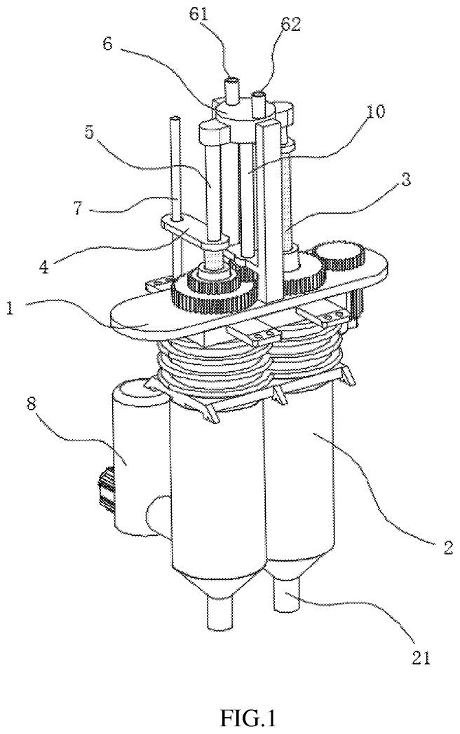

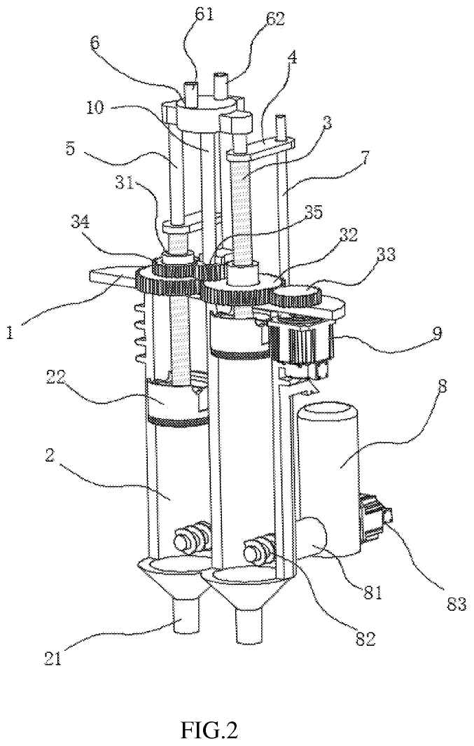

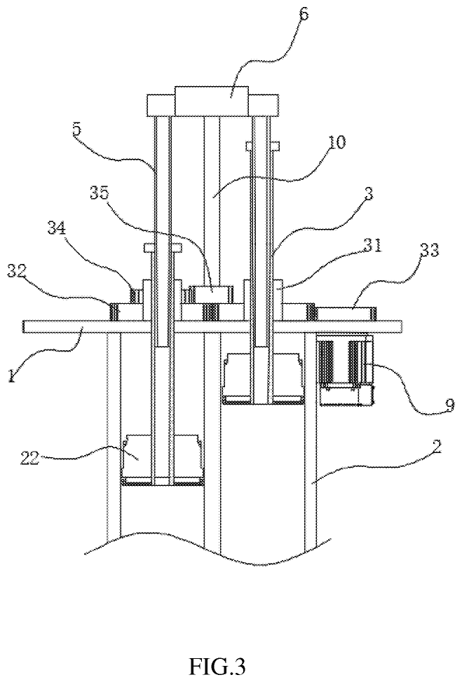

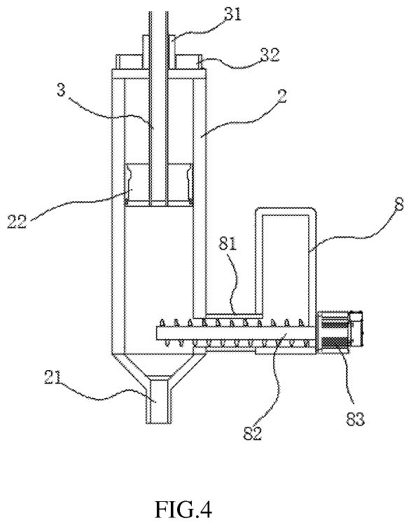

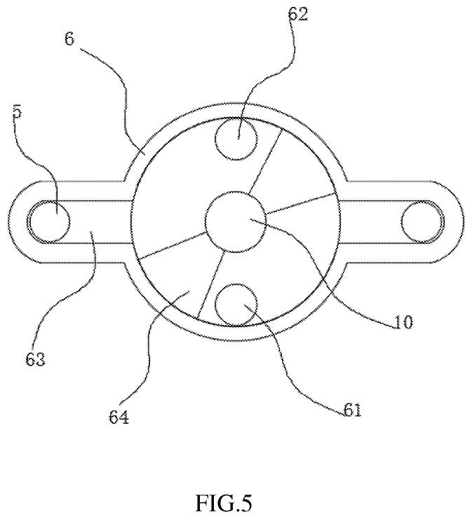

Referring to FIGS. 1-5, a liquid chromatography piston in an embodiment of the present application includes:
a connecting plate 1, below which two chromatographic columns 2 are fixed, each of the two chromatographic columns 2 is internally filled with a stationary phase packing, and is provided at its lower end with a liquid outlet 21, and the liquid outlet 21 is connected to a continuous chromatograph;
two pistons 22, each slidably disposed within a respective chromatographic column 2 and located above the stationary phase packing. A threaded tube 3 is fixed above each of the two pistons 22. An outer wall of the threaded tube 3 is formed with threads. The upper end of the thread tube passes through the connecting plate 1 and extends upwards, while the lower end thereof passes through the piston 22 and is fixedly connected to a bottom of the piston 22;
two nuts 31, which are rotatably arranged on the connecting plate 1 and respectively in threaded connection with the two threaded tubes 3, by rotating the nut 31, a position of the piston 22 within the chromatographic column 2 can be adjusted, thereby changing a column length and a column pressure of the chromatographic column 2;
two connecting strips 4, which are respectively fixed to upper ends of the threaded tubes 3; and
two liquid inlet tubes 5, which are respectively slidably arranged within the threaded tubes 3, upper ends of the two liquid inlet tubes 5 are fixedly connected to a same flow guide 6 after respectively pass through connecting strips 4, the flow guide 6 is fixed above the connecting plate 1, a sample tube 61 and a cleaning agent tube 62 are provided above the flow guide 6, the sample tube 61 is configured to introduce a mobile phase sample, and the cleaning agent tube 62 is configured to introduce a cleaning agent.

By rotating the two nuts 31 respectively, the pistons 22 can slide downward and compress the stationary phase packings within the corresponding chromatographic columns 2, thereby respectively adjusting column lengths of the stationary phase packings within the chromatographic columns 2. The longer the column length is, the longer the distance that the mobile phase sample travels through the stationary phase packing.

For samples with a simple structure and fewer components, a shorter chromatographic column is generally sufficient to meet the separation requirements. Although the separation efficiency of a short column is relatively lower, it is sufficient for simple samples. The short column can also shorten analysis time and improve analytical efficiency. For samples with a complex structure and many components, a longer chromatographic column is needed to achieve better separation effect. A long column provides higher separation efficiency and resolution, thus being able to better separate various components within the sample.

Simultaneously, compressing the stationary phase packing may increase the column pressure in the chromatographic column 2, thereby increasing the packing density of the stationary phase packing. The greater the packing density, the larger the contact area between the packing and sample molecules, thus improving resolution. This helps to better separate various components in a mixture, but it may decrease a flow rate of the mobile phase sample and require a higher pump pressure to drive the mobile phase sample to flow within the chromatographic column 2.

When the piston 22 slides upward to reduce the column pressure in the chromatographic column 2, the cleaning agent can be introduced into the chromatographic column 2. In this state, due to the lower packing density of the stationary phase packing, the cleaning agent can flow adequately within the stationary phase packing to carry away residual sample, thereby improving cleaning efficiency.

In the present embodiment, sieve plates are respectively disposed at lower ends of the threaded tubes 3 and the liquid outlets 21 to prevent the stationary phase packing from flowing out.

In the present embodiment, two vertical guide rods 7 are fixed above the connecting plate 1. The two connecting strips 4 are respectively slidably sleeved on the two guide rods 7. The guide rod 7 can restrict the rotation of the connecting strip 4, thereby preventing the threaded tubes 3 from rotating on their own.

In the present embodiment, a lifting gear 32 is fixedly sleeved on an outer side of each nut 31, and the two lifting gears 32 mesh with each other.

A drive gear 33 is rotatably provided on the connecting plate 1. The drive gear 33 meshes with one of the lifting gears 32.

A gear drive motor 9 configured to drive the lifting gears 32 to rotate is connected below the connecting plate 1.

That is, the gear drive motor 9 can drive the nuts 31 to rotate, thereby causing the pistons 22 to slide. Since the two lifting gears 32 mesh with each other, the two nuts 31 always rotate synchronously in opposite directions, and thus the two pistons 22 always slide synchronously in opposite directions. As a result, while the column pressure in one chromatographic column 2 increases and the mobile phase sample is introduced for separation, the column pressure in the other chromatographic column 2 decreases and the cleaning agent is introduced for cleaning. The two chromatographic columns 2 can thereby sequentially output separated samples, enabling continuous introduction of the mobile phase sample and continuous output of separated samples, achieving continuous separation and purification of samples and improving the efficiency of chromatography analysis.

In the present embodiment, a storage tank 8 is fixedly connected behind each chromatographic column 2. Each storage tank 8 is filled with the stationary phase packing. A lower portion of the chromatographic column 2 communicates with the respective storage tank 8 through a connecting tube 81.

In the present embodiment, a transport screw 82 is rotatably provided within the connecting tube 81. The transport screw 82 is fitted with an inner wall of the connecting tube 81. A first end of the transport screw 82 extends into the chromatographic column 2, and a second end thereof rotatably passes through the storage tank 8.

A screw drive motor 83 configured to drive the transport screw 82 to rotate is provided outside the storage tank 8.

The screw drive motor 83 drives the transport screw 82 to rotate, enabling the stationary phase packing in the corresponding storage tank 8 to be exchanged with the stationary phase packing in the chromatographic column 2, thereby increasing or decreasing the amount of the stationary phase packing in the chromatographic column 2, and thus further adjusting the column pressure at a fixed column length.

Different samples may require different column pressures to achieve optimal separation. The adjustable column pressure allows the chromatographic column 2 to be applicable to a wider range of sample types and analytical needs, helping improve the resolution between different components and form a good chromatography peak shape in a chromatograph, avoiding undesirable phenomena such as peak broadening and tailing, and thus improving accuracy and reliability of analytical results.

In the present embodiment, the flow guide 6 is a cylindrical cavity with side cavities 63 on its two sides respectively. The two liquid inlet tubes 5 respectively extend into the two side cavities 63.

The sample tube 61 and the cleaning agent tube 62 respectively lead into the flow guide 6 at a front side and a rear side thereof.

In the present embodiment, a rotating shaft 10 is rotatably connected to a center of the flow guide 6. Two symmetrical arranged flow guide plates 64 are respectively fixed on two sides of the rotating shaft 10. The flow guide plates 64 are sector-shaped, and an arc length of each is greater than both an inner diameter of the sample tube 61 and an inner diameter of the cleaning agent tube 62 and is also greater than a width of the side cavity 63. Two ends of each flow guide plate 64 are fitted with an inner wall of the flow guide 6.

That is, rotating the rotating shaft 10 may drive the flow guide plate 64 to rotate. When the flow guide plate 64 rotates to a position where the sample tube 61 communicates with one liquid inlet tube 5, the cleaning agent tube 62 communicates with the other liquid inlet tube 5, thereby enabling one chromatographic column 2 to separate a sample while the other chromatographic column 2 is cleaned.

In the present embodiment, a lower end of the rotating shaft 10 passes through the flow guide 6 and extends out from a lower side thereof. A flow guide gear 35 is fixed to the lower end of the rotating shaft 10. The flow guide gear 35 is rotatably mounted above the connecting plate 1.

A transmission ring gear 34 is fixed to one of the lifting gears 32. The transmission ring gear 34 meshes with the flow guide gear 35.

When the lifting gears 32 rotate, they drive the rotating shaft 10 to rotate. Furthermore, when the piston 22 inside one chromatographic column 2 slides downward to compress the stationary phase packing, the sample tube 61 communicates with the liquid inlet tube 5 corresponding to this chromatographic column 2, while the cleaning agent tube 62 communicates with the liquid inlet tube 5 corresponding to the other chromatographic column 2.

That is, the flow guide 6 is capable of automatically delivering the mobile phase sample into one chromatographic column 2 in which the stationary phase packing is compressed, while delivering the cleaning agent into the other chromatographic column 2 in which the stationary phase packing is released, thereby enabling the chromatographic columns 2 to subsequently perform sample separation and cleaning, and thus improving the purity of separation.

During specific implementation, the following steps are included:

### Sample Separation Process

The gear drive motor 9 reciprocally rotates to drive the nuts 31 to rotate, thereby driving the pistons 22 to slide within the chromatographic columns 2. As the two lifting gears 32 mesh with each other, the two pistons 22 will slide synchronously in opposite directions.

When the piston 22 slides downward, it compresses the stationary phase packing within its corresponding chromatographic column 2, thereby increasing the column pressure. The increase in column pressure increases the packing density of the stationary phase packing, which in turn increases the contact area between the packing and the sample molecules, and improving the resolution.

While adjusting the column pressure, the mobile phase sample is introduced into the flow guide 6 through the sample tube 61. The flow guide 6 automatically selects which chromatographic column 2 to deliver the sample to according to the current position of the pistons 22.

While one chromatographic column 2 is performing sample separation, the other chromatographic column 2 is in a cleaning state. The cleaning agent is introduced into the flow guide 6 through the cleaning agent tube 62 to clean residual sample within the chromatographic column 2. The separated sample flows out from the liquid outlet 21 of the chromatographic column 2 and enters the continuous chromatograph for further analysis or collection.

### Stationary Phase Packing Adjustment

When it is necessary to adjust an amount of the stationary phase packing within the chromatographic column 2, the screw drive motor 83 is activated to drive the transport screw 82 to rotate. The rotation of the transport screw 82 enables the stationary phase packing in the storage tank 8 with the packing in the chromatographic column 2, thereby adjusting the amount of the packing within the chromatographic column 2. Before adjusting the amount of the stationary phase packing within the chromatographic column 2, the stationary phase packing within the chromatographic column 2 should have been cleaned and no new mobile phase sample should be introduced.

The above are all the exemplary embodiments of the present application, but the protection scope of the present application is not limited thereto. Any equivalent replacements or modifications made by a person skilled in the art, within the technical scope disclosed in the present application and according to the technical solutions and inventive concepts of the present application, shall all fall within the protection scope of the present application.

### LIST OF REFERENCE SIGNS

1 connecting plate
2 chromatographic column
21 liquid outlet
22 piston
3 threaded tube
31 nut
32 lifting gear
33 drive gear
34 transmission ring gear
35 flow guide gear
4 connecting strip
5 liquid inlet tube
6 flow guide
61 sample tube
62 cleaning agent tube
63 side cavity
64 flow guide plate
7 guide rod
8 storage tank
81 connecting tube
82 transport screw
83 screw drive motor
9 gear drive motor
10 rotating shaft

What is claimed is:

1. A liquid chromatography piston, comprising:
a connecting plate, wherein two chromatographic columns are fixed below the connecting plate, each of the two chromatographic columns is internally filled with a stationary phase packing and is provided with a liquid outlet at a lower end of each of the two chromatographic columns, and the liquid outlet is connected to a continuous chromatograph,
two pistons, wherein the two pistons are respectively slidably disposed within the two chromatographic columns and located above the stationary phase packing, a threaded tube is fixed above each of the two pistons, an outer wall of the threaded tube is provided with threads, an upper end of the threaded tube passes through the connecting plate and extends upwards, and a lower end of the threaded tube passes through a respective one of the two pistons and is fixedly connected to a bottom of a respective one of the two pistons,
two nuts, wherein the two nuts are rotatably disposed on the connecting plate and respectively in threaded connection with the two threaded tubes, rotating each of the two nuts allows adjustment of a position of a respective one of the two pistons within a respective one of the two chromatographic columns, thereby changing a column length and a column pressure of a respective one of the two chromatographic columns,
two connecting strips, wherein the two connecting strips are respectively fixed to the upper ends of the two threaded tubes, and
two liquid inlet tubes, wherein the two liquid inlet tubes are respectively slidably arranged within the two threaded tubes, upper ends of the two liquid inlet tubes respectively pass through the two connecting strips and are fixedly connected to a same one flow guide, the flow guide is fixed above the connecting plate, a sample tube and a cleaning agent tube are provided above the flow guide, the sample tube is configured to introduce a mobile phase sample, and the cleaning agent tube is configured to introduce a cleaning agent.

2. The liquid chromatography piston according to claim 1, wherein sieve plates are respectively disposed at the lower ends of the two threaded tubes and at the liquid outlets.

3. The liquid chromatography piston according to claim 1, wherein two vertical guide rods are fixed above the connecting plate, and the two connecting strips are respectively slidably sleeved on the two vertical guide rods.

4. The liquid chromatography piston according to claim 1, wherein a lifting gear is fixedly sleeved on an outer side of each of the two nuts, and the two lifting gears mesh with each other,
wherein a drive gear is rotatably disposed on the connecting plate, and the drive gear meshes with one of the two lifting gears, and
a gear drive motor configured to drive the two lifting gears to rotate is connected below the connecting plate.

5. The liquid chromatography piston according to claim 1, wherein a storage tank is fixedly connected behind each of the two chromatographic columns, the storage tank is filled with the stationary phase packing, and a lower portion of each of the two chromatographic columns communicates with the storage tank via a connecting tube.

6. The liquid chromatography piston according to claim 5, wherein a transport screw is rotatably provided within the connecting tube, the transport screw is fitted against an inner wall of the connecting tube, a first end of the transport screw extends into a respective one of the two chromatographic columns, and a second end of the transport screw rotatably passes through the storage tank and extends out of the storage tank, and
a screw drive motor configured to drive the transport screw to rotate is provided outside the storage tank.

7. The liquid chromatography piston according to claim 4, wherein the flow guide is a cylindrical cavity with side cavities respectively on two sides of the flow guide, and the two liquid inlet tubes respectively lead into the two side cavities, and
the sample tube and the cleaning agent tube respectively lead into the flow guide at a front side and a rear side of the flow guide.

8. The liquid chromatography piston according to claim 7, wherein a rotating shaft is rotatably connected to a center of the flow guide, two symmetrically arranged flow guide plates are respectively fixed on two sides of the rotating shaft, each of the two symmetrically arranged flow guide plates is sector-shaped and has an arc length greater than both an inner diameter of the sample tube and an inner diameter of the cleaning agent tube as well as a width of each of the two side cavities, and ends of the two symmetrically arranged flow guide plates are respectively fitted against an inner wall of the flow guide.

9. The liquid chromatography piston according to claim 8, wherein a lower end of the rotating shaft passes through the flow guide and extends out from a lower side of the flow guide, a flow guide gear is fixed to the lower end of the rotating shaft, and the flow guide gear is rotatably erected above the connecting plate, and
a transmission ring gear is fixed to one of the two lifting gears, and the transmission ring gear meshes with the flow guide gear.

10. The liquid chromatography piston according to claim 9, wherein the one of the two lifting gears rotate to drive the rotating shaft to rotate, and when one of the two pistons in a first of the two chromatographic columns slides downward to compress the stationary phase packing, the sample tube communicates with a respective one of the two liquid inlet tubes corresponding to the first of the two chromatographic columns, and the cleaning agent tube communicates with a respective one of the two liquid inlet tubes corresponding to a second of the two chromatographic columns.
